(19) United States
(12) Patent Application Publication
(10) Pub. No.: US 2010/0050953 A1
(43) Pub. Date: Mar. 4, 2010

(54) Cat Climbing and Scratching System

(76) Inventor: Harlan Wayne Fails, JR., Chicago, IL (US)

Correspondence Address: Harlan Wayne Fails, Jr., 3341 W Sunnyside Ave #2, Chicago, IL, 60625, US

(21) Appl. No.: 12/203,075

(22) Filed: Sep. 2, 2008

(51) Int. Cl. A01K 15/02

(52) U.S. Cl. 119/706

(57) ABSTRACT

One embodiment of a symmetrical elongated device for a cat to climb and of the type having a length of rope (16) that communicates with the board (10) through the holes (14A-D). The board (10) may be solid or hollow and may be stiff or flexible. In addition, a length of webbing (18) communicates with the board (10) through the slots (14A and 14B). The webbing (18) is secured to the board (10) using fabric hook and loop fasteners that are firmly attached to the webbing (18). The device mounts on a door using a lasso method wherein the device along with the webbing (18) create a loop which goes completely around the door and is pulled tight. The spacers (22) provide additional stability for the device when attached to a door.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This invention relates to animal exerciser or toy, specifically to a cat climbing and scratching system.

2. Prior Art

Pet product suppliers commonly provide pet owners with a selection of products intended to give domesticated cats a surface for scratching to maintain their claws and protect furniture. While many products in the marketplace suffice for this requirement of cats, none adequately addresses an equally important need that cats have: to exercise in the form of climbing.

Indoor cats are especially vulnerable to the many negative side-effects resulting from a lack of exercise. Just as in humans, lack of exercise in cats can lead to unhealthy weight gain and loss of muscle tone leading to poor health and a shorter life expectancy. For young cats, especially, unexpended pent-up energy often leads to behaviours that are destructive to indoor surfaces. In the outdoors, cats instinctively seek out opportunities to climb. Indoors, few such opportunities have existed.

Originally cat owners wishing to provide their pets with an indoor climbing opportunity have had no adequate options. The so-called cat “tree,” of which there are many varieties, usually only provides a series of perches or, at best, a very short distance for making a vertical climb. Those that do provide a vertical climb do so at the expense of interior space functionality and integrity or are complicated and expensive to construct.

U.S. Pat. No. 5,450,819 to Gray (1995) shows an elongated device wrapped with rope; however, the device is not designed for climbing but only for clawing at the rope to get at the catnip. Nor is there any provision for attaching the device to a door. The device appears overly complicated and would likely be too expensive for mass-market consumption.

U.S. Pat. No. 5,829,390 to Jonilla and Jonilla (1998) describes a device that attaches over the top of a door frame. This device does not provide a vertical climb for a cat but only a series of perches or steps.

U.S. Pat. Application Pub. No. US 2003/0000483 A1 to Haber (2003) describes a device that purports to provide a vertical climbing experience for indoor cats. While it may in part fulfill that intention, the device impedes the function of the door since it attaches to the inside of the door frame. It also has the potential to leave significant marks on the door frame due to its use of clamps for installation. In addition, it appears complicated to construct and difficult to install and remove.

U.S. Pat. No. 3,479,991 to Lichtenberger (1968) describes a device for cats to climb; however the device attaches between the ceiling and floor and has perches. Numerous other floor-to-ceiling devices exist. These take up floor space and do not provide a true climbing experience for a cat.

### SUMMARY

In accordance with one embodiment a cat climbing and scratching system comprises an elongated support piece covered with a material suitable for a cat to climb and attached to a door via a length of flexible and strong material.

### DRAWINGS—FIGURES

FIG. 1 is a perspective view of a cat climbing and scratching system in accordance with an embodiment of the present invention.

FIG. 2 is a perspective view of a cat climbing and scratching system showing the lasso method of installation on a door.

FIG. 3 is a front perspective view of a cat climbing and scratching system mounted to a door.

DRAWINGS-Reference Numerals

| | | | |
|---|---|---|---|
| 10 | board | 12A | slot |
| 12B | slot | 14A | hole |
| 14B | hole | 14C | hole |
| 14D | hole | 16 | rope |
| 18 | webbing | 20A | fabric hook fastener |
| 20B | fabric loop fastener | 20C | fabric hook fastener |
| 20D | fabric loop fastener | 22 | spacers |

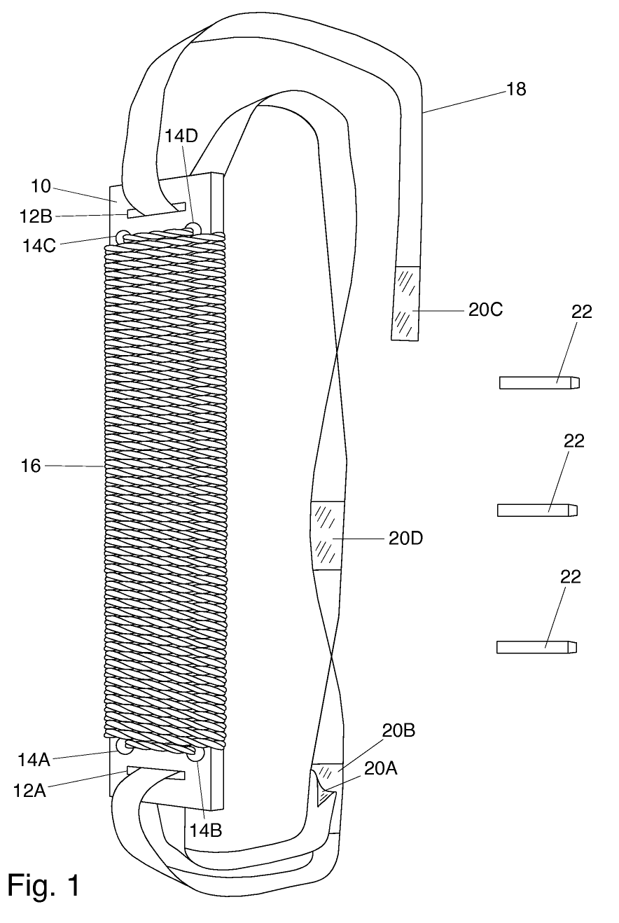

### DETAILED DESCRIPTION—FIG. 1—PREFERRED EMBODIMENT

One embodiment of this climber is illustrated in FIG. 1 (perspective view). The climber has an elongated board 10. In this embodiment, board 10 is made of wood; however, board 10 may be made of many other types of material, such as plastic, metal, rubber, or may consist of a composition of materials. Board 10 may be hollow or solid and may be stiff or flexible.

With board 10 positioned in portrait orientation with respect to and facing the subject, board 10 has a top, bottom, front and back.

Near the bottom of board 10 a slot 12A is contemplated. Near the top of board 10 a slot 12B is contemplated.

Near the bottom of board 10 a hole 14A and a hole 14B are contemplated. Near the top of board 10 a hole 14C and a hole 14D are contemplated.

In the current embodiment, a length of rope 16 suitable for a cat to climb is contemplated. Rope 16 consists of sisal rope; however, many other materials will work well as a climbable surface for a cat, such as cotton rope, rubber, and textile products such as carpet.

Beginning at the bottom and back of board 10, one end of rope 16 is threaded through hole 14A. Rope 16 is pulled through hole 14A only a short distance. The end of rope 16 that is now protruding from the front of board 10 through hole 14A is inserted into hole 14B from the direction of the front of board 10. Glue is applied to the inside of hole 14B. Any excess of rope 16 that is protruding from the back of board 10 at hole 14B is trimmed flush with board 10.

Moving in either a right-to-left or a left-to-right direction, rope 16 is wound tightly and closely around board 10 continuing until board 10 is mostly covered by rope 16.

From the position of the top and back of board 10, the remaining unsecured end of rope 16 is threaded through hole 14C. Rope 16 is pulled firmly through hole 14C to remove slack. The end of rope 16 that is now protruding from the front of board 10 through hole 14C is inserted into hole 14D from the direction of the front of board 10. Glue is applied to the inside of hole 14D. Any excess of rope 16 that is protruding from the back of board 10 at hole 14D is trimmed flush with board 10. This method of securing rope 16 through holes 14A-D is only one of many ways rope 16 may be secured. Others methods include the use of glue, staples or hardware brackets.

Continuing with FIG. 1, a length of webbing 18 is contemplated for use to secure the device to a suitable vertical surface such as a door. In the current embodiment, webbing 18 is made of polyethylene; however, many other types of material will suffice, such as cotton webbing, leather or fabric made of natural or artificial fibers.

One end of webbing 18 is designated the bottom end corresponding to the bottom end of board 10. The other end of webbing 18 is designated the top end corresponding to the top end of board 10.

At the far extremity of the bottom end of webbing 18, a piece of fabric hook fastener 20A is sewn to one side of webbing 18. At a short distance from fastener 20A a piece of fabric loop fastener 20B is sewn to the same side of webbing 18.

At the far extremity of the top end of webbing 18, a piece of fabric hook fastener 20C is sewn to webbing 18 on the opposite side as that of fastener 20A and fastener 20B.

A piece of fabric loop fastener 20D is sewn to webbing 18 on the same side as fastener 20C at a distance from fastener 20C so as to ensure alignment of fastener 20C and fastener 20D when the device is installed on a suitable vertical surface such as a door.

The end of webbing 18 that has fastener 20A attached is threaded through slot 12A starting from the front of board 10 and with fastener 20A facing down. Fastener 20A is then brought into contact with fastener 20B creating a bond. The bottom end of webbing 18 is thus secured to the bottom end of board 10 through slot 12A.

The end of webbing 18 that has fastener 20C attached is threaded through slot 12B starting from the back of board 10 and with fastener 20C facing up. The end of webbing 18 having fastener 20C attached is pulled through slot 12B a short distance and left hanging loose until installation.

This method of securing webbing 18 through slots 12A-B is one among may methods by which webbing 18 may be secured to board 10. Other methods include the use of hardware brackets or shallow slots that do not penetrate board 10 all the way through.

A plurality of spacers 22 (FIG. 1) are provided to enhance stability when the device is secured to a suitable vertical surface such as a door. In the present embodiment, spacers 22 are made of rubber, but other materials will suffice, such as wood, plastic or a wide array of composite materials both natural and artificial.

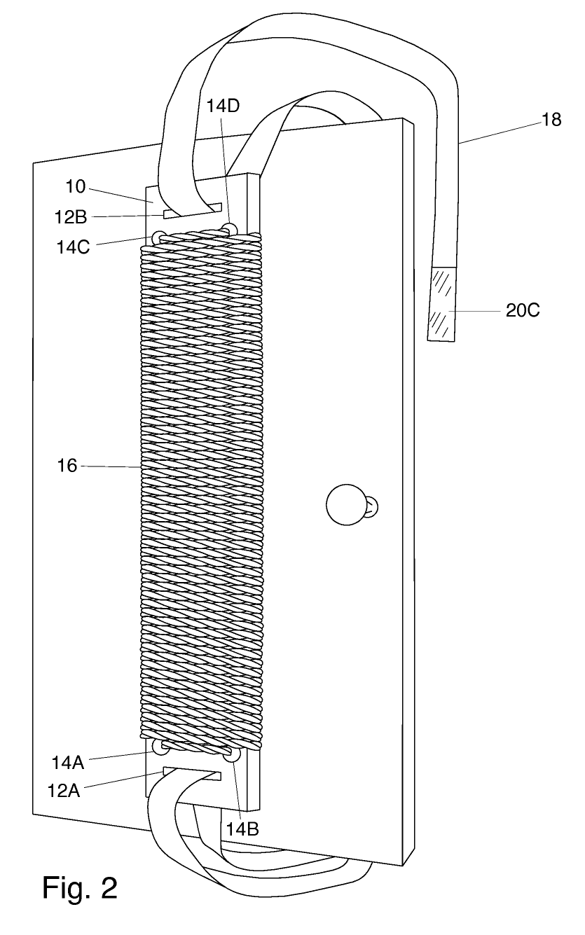

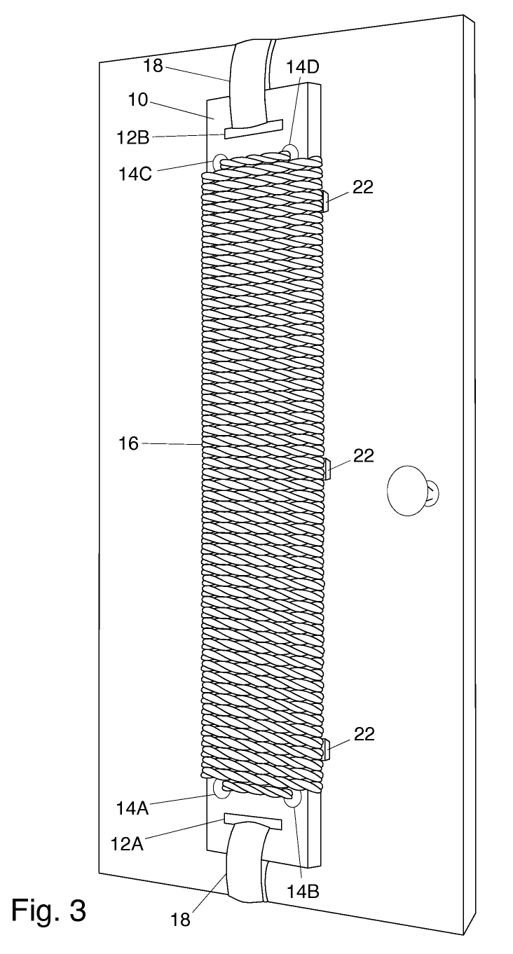

### Operation—FIGS. 2 and 3

As shown in FIGS. 2 and 3 (both perspective views) the climber is installed on a door or similar vertical surface by a lasso method. With board 10 and webbing 18 forming an open loop (FIG. 2), the device is installed around an open door in a vertical orientation. By positioning the device over the door, the door is effectively brought into the loop. A lasso effect is created around the door.

Once the device is positioned on a door, the end of webbing 18 having fastener 20C attached is pulled down firmly to remove slack thereby creating a tight lasso effect around the door (FIG. 3). Fastener 20C is engaged with fastener 20D thus creating a bond that will sustain the tight lasso effect.

Spacers 22 are pressed between the door and the device at appropriate intervals in order to prevent the device from moving from side-to-side when the cat climbs the device and also to provide protection for the door (FIG. 3).

### Advantages

From the description above, a number of advantages of the embodiment of my cat climbing and scratching system become evident:

a) The device provides an indoor climbing experience for a cat akin to climbing a tree trunk.

b) It does not impede the function of the door. Since webbing (18) is flexible, the door can be closed with the device installed.

c) It takes up no floor space.

d) It installs easily and does not require any tools or skill to install.

e) It does not require the use of any hardware that could damage indoor surfaces.

f) It is lightweight and easy to install and remove.

g) It is cost-effective and simple to produce.

h) In the preferred embodiment, no metal is used. Therefore it has a high degree of safety for cats.

It is durable and reversible offering years of useful life.

Until now no device has offered the pet owner with a solution that gives their cat a true indoor vertical climbing experience, takes up no floor space, requires no drilling or cutting into interior surfaces, requires no tools or skill to install, does not impede the function of interior surfaces such as a door and is very simple and inexpensive to manufacture.

### Conclusion, Ramifications and Scope

Accordingly, the reader will see that this device is truly revolutionary in the field of cat exerciser products. While simple in design, it answers the previously unmet need for cats while indoors to exercise their instinct to climb and thus maintain their physical health and well-being. Its simplicity of design and the availability and affordability of components assures its accessibility to cat owners everywhere.

While my above description contains many specificities, these should not be construed as limitations on the scope of the invention, but rather as an exemplification of the preferred embodiment thereof. Many other variations are possible.

Accordingly, the scope of the invention should be determined not by the embodiment illustrated, but by the appended claims and their legal equivalents.

I claim:

1. A cat climbing and scratching device comprising:
a) an elongated symmetrical shaped member;
b) a wrap covering said member, said wrap having characteristics that provide a surface for a cat to climb;
c) an elongated flexible material for use in securing said member with said wrap to a door, said material engaging said member at each end of said member and, along with said member, said material creating a loop, said loop wrapping completely around said door.
